(19) United States
(12) Patent Application Publication
(10) Pub. No.: US 2021/0062927 A1
(43) Pub. Date: Mar. 4, 2021

(54) PRESSURE RELIEF VALVE, SERVICE SYSTEM, AND METHOD FOR SERVICING PRESSURE RELIEF VALVE

(71) Applicant: Caterpillar Inc., Peoria, IL (US)

(72) Inventors: Brian George Tyler, Trevor, WI (US); Nickolas Jay Gretz, Lake in the Hills, IL (US)

(73) Assignee: Caterpillar Inc., Peoria, IL (US)

(21) Appl. No.: 16/552,628

(22) Filed: Aug. 27, 2019

(51) Int. Cl. F16K 17/04; F16K 15/04; F16K 17/06

(52) U.S. Cl. CPC F16K 17/0493; F16K 17/0406; F16K 27/0209; F16K 17/06; F16K 15/046

(57) ABSTRACT

A pressure relief valve may include a housing and a seat portion in flow communication with an inlet passage. The pressure relief valve may also include a relief body configured to abut the seat portion and provide a fluid seal between the inlet passage and an outlet passage, and a keeper abutting the relief body. The pressure relief valve may also include an intermediate sleeve coupled to the housing and at least one waveform spring configured to abut the keeper and resist movement of the relief body and the keeper away from the seat portion, such that the relief body prevents flow communication between the inlet passage and the outlet passage. The pressure relief valve may further include an end cap including a shoulder abutting the end surface of the intermediate sleeve and a reaction surface against which an end of the at least one waveform spring abuts.

### TECHNICAL FIELD

The present disclosure relates to a pressure relief valve, a service system, and a method for servicing a pressure relief valve, and more particularly, to a pressure relief valve including one or more waveform springs, a service system for a pressure relief valve including one or more waveform springs, and a method for servicing a pressure relief valve including associating one or more waveform springs with a pressure relief valve.

### BACKGROUND

A pressure relief valve may be used to prevent pressure in a fluid system from exceeding a threshold pressure. For example, a pressure relief valve may be in flow communication with a fluid system and configured to relieve pressure from the fluid system when the pressure exceeds the threshold pressure. This may be effective in preventing and/or reducing damage to components of the fluid system and/or an increase in pressure beyond desired limits. Some pressure relief valves may include one or more spring relief washers configured to result in the pressure relief valve relieving pressure at a desired threshold pressure, and some pressure relief valves may include an adjustment screw configured to adjust the threshold pressure to a desired threshold pressure. In some pressure relief valves including spring relief washers, the spring relief washers may be manipulated to change the threshold pressure. However, in some such pressure relief valves, manipulation of the spring relief washers and adjustment of the threshold pressure via the adjustment screw may be relatively complex procedures that sometimes lead to the pressure relief valve not releasing pressure in the fluid system at the desired threshold pressure.

An attempt to provide a self-piloted check valve is described in U.S. Pat. No. 9,309,979 B2 to Russell (“the '979 patent”), issued Apr. 12, 2016. Specifically, the '979 patent describes a self-piloted check valve using closure of a piloting flapper valve to permit development of closure forces for a ball valve. According to the '979 patent, the normally open ball valve has a central flow passage and simultaneously rotates and translates as it traverses between its fully open and fully closed positions. An opening bias system utilizes a combination of a first less-stiff spring and a second stiffer spring. A reversible decoupling means disconnects and reconnects the second spring at a short travel distance from the normally open position of the ball, while the first spring provides opening bias forces to the ball. According to the '979 patent, the pressure-induced force required to fully close the ball valve following decoupling of the second spring is more than the force required to overcome the combination of the first and second springs. While the secondary spring is engaged, hydrodynamic damping of the ball opening movement is purportedly provided.

Although the '979 patent purports to describe a valve including two springs, the '979 patent does not describe a pressure relief valve addressing the above-noted concerns sometimes associated with pressure relief valves. The pressure relief valves, servicing systems, and/or methods disclosed herein may be directed to addressing one or more of the possible concerns set forth above.

### SUMMARY

According to a first aspect, a pressure relief valve may include a housing defining an inlet passage for providing flow communication with a fluid source and an outlet passage spaced from the inlet passage. The pressure relief valve may also include a seat portion in flow communication with the inlet passage. The seat portion may define a sealing surface, and the pressure relief valve may also include a relief body configured to abut the sealing surface and provide a fluid seal between the inlet passage and the outlet passage. The pressure relief valve may also include a keeper including an engagement surface abutting the relief body, and a relief stem associated with the keeper and extending away from the relief body. The pressure relief valve may also include an intermediate sleeve coupled to the housing. The intermediate sleeve may define an end surface and may at least partially define a relief cavity in which the relief stem is received. The pressure relief valve may also include at least one waveform spring received in the relief cavity and including a first end configured to abut the keeper and resist movement of the relief body and the keeper away from the seat portion, such that the relief body prevents flow communication between the inlet passage and the outlet passage. The pressure relief valve may further include an end cap including a shoulder abutting the end surface of the intermediate sleeve and a reaction surface which a second end of the at least one waveform spring abuts.

According to a further aspect, a service system for servicing a pressure relief valve including a plurality of spring relief washers and an adjustment screw for adjusting a threshold pressure at which the pressure relief valve opens, may include at least one waveform spring configured to be received in a relief cavity of the pressure relief valve and replace at least some of the plurality of spring relief washers. The at least one waveform spring may include a first end and may be configured to resist movement of a relief body away from a seat portion configured to be in flow communication with an inlet passage of the pressure relief valve, such that the relief body prevents flow communication between the inlet passage and an outlet passage of the pressure relief valve. The service system may also include an end cap including a shoulder configured to abut an end surface of the pressure relief valve, and a reaction surface configured to abut a second end of the at least one waveform spring.

According to another aspect, a method for servicing a pressure relief valve including a plurality of spring relief washers and an adjustment screw for adjusting a threshold pressure at which the pressure relief valve opens, may include separating the adjustment screw from the pressure relief valve. The method may also include separating an intermediate sleeve from the pressure relief valve to provide access to the plurality of spring relief washers. The method may further include separating at least some of the plurality of spring relief washers from the pressure relief valve, and associating at least one waveform spring with the pressure relief valve as a replacement for the at least some of the plurality of spring relief washers. The method may also include coupling the intermediate sleeve to the pressure relief valve, and coupling an end cap to the pressure relief valve as a replacement for the adjustment screw, such that a shoulder of the end cap abuts an end surface of the intermediate sleeve and a reaction surface of the end cap abuts an end of the at least one waveform spring.

### BRIEF DESCRIPTION OF THE DRAWINGS

The detailed description is described with reference to the accompanying figures. The same reference numbers in different figures indicate similar or identical items.

FIG. 1 is a schematic diagram showing an example fluid system including a side section view of an example pressure relief valve in an example closed state in flow communication with the fluid system.

FIG. 2 is a schematic side section view of the example pressure relief valve shown in FIG. 1 in an example open state.

FIG. 3 is a schematic side section view of another example pressure relief valve in an example closed state.

FIG. 4 is a schematic side section view of another example pressure relief valve in an example closed state.

FIG. 5 is a schematic side section view of the example pressure relief valve shown in FIG. 4 during an example servicing procedure.

FIG. 6 is a schematic side section view of the example pressure relief valve shown in FIG. 4 during the example servicing procedure using an example service system including example replacement parts being associated with the pressure relief valve.

FIG. 7 illustrates a flow diagram of an example process for servicing a pressure relief valve.

### DETAILED DESCRIPTION

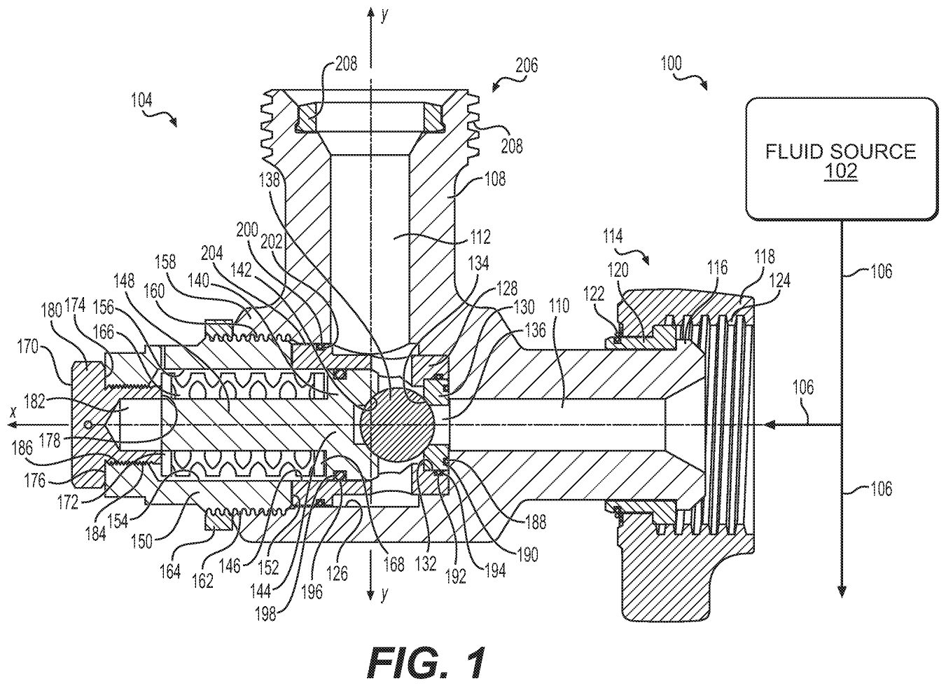

FIG. 1 is a block diagram of an example fluid system 100 including a fluid source 102 in flow communication with an example pressure relief valve 104 via one or more fluid lines 106 providing flow communication. Fluid system 100 may be used to communicate one or more liquids, gases, semi-solids, and/or solids via fluid lines 106, for example, from fluid source 102, which may include, for example, one or more reservoirs, pumps, compressors, wells, etc. For example, fluid system 100 may include one or more fuel systems, lubrication systems, cooling systems, irrigation systems, refrigerant systems, pumping systems, compression systems, well systems, fluid delivery systems, and/or air systems. Some examples of pressure relief valve 104 may be in flow communication with fluid system 100 and may be configured to relieve pressure in fluid system 100, for example, when the pressure in fluid system 100 reaches or exceeds a threshold pressure corresponding to a highest desired pressure in fluid system 100. For example, pressure relief valve 104 may be configured to prevent the pressure in fluid system 100 from exceeding a maximum desired pressure, which may serve to reduce the likelihood or prevent the pressure in fluid system 100 from damaging components of fluid system 100 and/or creating an undesirable condition. As shown in FIG. 1, example pressure relief valve 104 is shown in an example closed state, which prevents flow of fluid from fluid system 100 through pressure relief valve 104.

As shown in FIG. 1, example pressure relief valve 104 includes a housing 108 defining an inlet passage 110 providing flow communication with fluid source 102 via fluid lines 106 and an outlet passage 112 spaced from inlet passage 110. In the example shown, inlet passage 110 and outlet passage 112 define longitudinal axes X and Y, respectively, that are substantially perpendicular with respect to one another. Other relative orientations are contemplated. In the example shown in FIG. 1, housing 108 includes an inlet end 114 defining a substantially circular cross-section perpendicular to the longitudinal axis X of inlet passage 110. At a remote end of inlet end 114, example housing 108 defines an annular flange 116. A nut 118 for securing a fluid line to pressure relief valve 104 may be coupled to housing 108 at inlet end 114 via an annular ring 120 (e.g., a segmented ring) and/or a retaining ring 122. In the example shown, nut 118 defines interior threads 124 configured to receive complimentary threads associated with fluid lines 106, such that inlet passage 110 of pressure relief valve 104 is in flow communication with fluid system 100.

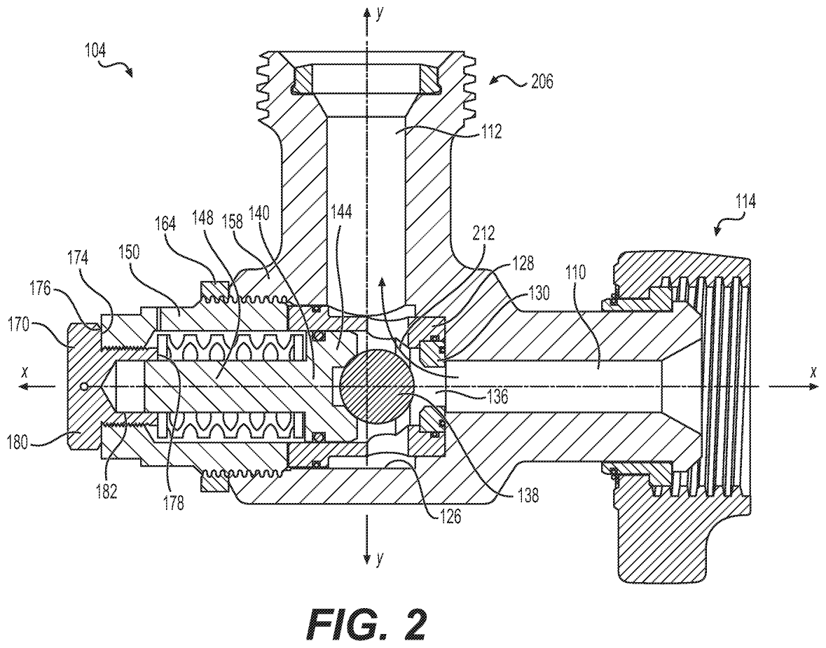

As shown in FIG. 1, example housing 108 also defines a chamber 126, for example, having a substantially circular cross-section perpendicular to the longitudinal axis X of inlet passage 110. Chamber 126 may be configured to provide flow communication between inlet passage 110 and outlet passage 112 when pressure relief valve 104 is in the open state and is acting to relieve pressure in fluid system 100 (see, e.g., FIG. 2). Example chamber 126 is configured to at least partially receive a cage 128, which may define a substantially cylindrical outer surface configured to be slidably received in chamber 126. In some examples, pressure relief valve 104 may include a seat portion 130 received in chamber 126 and in flow communication with inlet passage 110. For example, seat portion 130 may include an annular ring configured to be received in a recess 132 at an end of cage 128 facing inlet passage 110, for example, as shown in FIG. 1. In some examples, seat portion 130 defines a sealing surface 134, for example, an annular sealing surface defining a seat passage 136 configured to provide flow communication between inlet passage 110 and outlet passage 112 when pressure relief valve 104 is in the open state and acts to relieve pressure in fluid system 100.

As shown in FIG. 1, example pressure relief valve 104 includes a relief body 138 configured to abut sealing surface 134 and provide a fluid seal between inlet passage 110 and outlet passage 112 when pressure relief valve 104 is in the closed state and is not acting to relieve pressure in fluid system 100. As shown in FIG. 1, example sealing surface 134 is shaped to be complimentary to the surface of relief body 138 to improve the fluid seal between sealing surface 134 and relief body 138 when the pressure relief valve 104 is in the closed state and acting to prevent flow communication between inlet passage 110 and outlet passage 112. The example relief body 138 shown in FIG. 1 is spherical. Other configurations of relief body 138 and/or sealing surface 134 are contemplated.

The example pressure relief valve 104 shown in FIG. 1 includes a keeper 140 including an engagement surface 142 abutting relief body 138, for example, on a side of relief body 138 opposite sealing surface 134. In some examples, as relief body 138 moves away from sealing surface 134 toward an end of pressure relief valve 104 opposite inlet end 114, relief body 138 pushes against engagement surface 142 of keeper 140, thereby moving keeper 140 in a direction away from inlet end 114, resulting in pressure relief valve 104 relieving pressure in fluid system 100, for example, as shown in FIG. 2. In the example shown in FIG. 1, keeper 140 includes a piston portion 144 having a substantially cylindrical shape defining a substantially circular cross-section in a direction perpendicular to the longitudinal axis X and configured slide in a direction parallel to the longitudinal axis X with respect to example cage 128. For example, example cage 128 may define a cylindrical chamber 146 extending in a direction parallel to the longitudinal axis X, and piston portion 144 may be configured to slide at least partially within and relative to cylindrical chamber 146 as relief body 138 moves away from sealing surface 134 to open pressure relief valve 104. In the example shown, keeper 140 also includes a relief stem 148 associated with (e.g., coupled to) piston portion 144 on a side opposite relief body 138, and extending away from the piston portion 144 and relief body 138 in a direction substantially parallel to the longitudinal axis X.

In the example shown in FIG. 1, pressure relief valve 104 also includes an intermediate sleeve 150 coupled to housing 108, defining an end surface 152, and at least partially defining a relief cavity 154 in which relief stem 148 is received. For example, relief cavity 154 may define a cylindrical cavity 156 providing an extension of cylindrical chamber 146 at least partially defined by cage 128. In some examples, housing 108 of pressure relief valve 104 defines a fixture portion 158 at an end of housing 108 opposite inlet end 114 and configured to at least partially receive intermediate sleeve 150. In some examples, fixture portion 158 may define a substantially cylindrical inner surface provided with internal threads 160 configured to threadedly engage external threads 162 of intermediate sleeve 150. In some examples, pressure relief valve 104 may include a fastener 164 (e.g., a nut) configured to engage external threads 162 of intermediate sleeve 150 and secure intermediate sleeve 150 within fixture portion 158 of housing 108. In the example shown, intermediate sleeve 150 abuts cage 128 and prevents cage 128 from moving relative to housing 108, for example, in a direction parallel to the longitudinal axis X.

As shown in FIG. 1, some examples of pressure relief valve 104 include at least one waveform spring 166 received in relief cavity 154. For example, a coil of example waveform spring 166 is configured to abut keeper 140 and resist movement of relief body 138 and keeper 140 away from seat portion 130, for example, such that relief body 138 prevents flow communication between inlet passage 110 and outlet passage 112, for example, when pressure in inlet passage 110 is below a threshold pressure, and such that relief body 138 and keeper 140 move away from seat portion 130 when the pressure in inlet passage 110 is above the threshold pressure, thereby relieving pressure in inlet passage 110 and fluid system 100. For example, a first end 168 of waveform spring 166 may abut piston portion 144 (e.g., on a side opposite relief body 138), and waveform spring 166 may provide a biasing force against movement of relief body 138 away from seat portion 130. In some examples, waveform spring 166 may be selected to provide a desired biasing force and/or have a length, such that relief body 138 prevents flow communication between inlet passage 110 and outlet passage 112, for example, when pressure in inlet passage 110 is below a threshold pressure and such that relief body 138 and keeper 140 move away from seat portion 130 when the pressure in inlet passage 110 is above the threshold pressure, thereby relieving pressure in inlet passage 110 and fluid system 100.

As shown in FIG. 1, example pressure relief valve 104 also includes an end cap 170 configured to abut a second end 172 of waveform spring 166 to provide a reactive force against second end 172 of waveform spring 166 to provide a desired resistance to movement of relief body 138 away from seat portion 130. For example, as shown, example end cap 170 may include a shoulder 174 configured to abut an end surface 176 of intermediate sleeve 150 facing away from inlet end 114 of housing 108. Example end cap 170 may also include a reaction surface 178 against which second end 172 of waveform spring 166 abuts. For example, end cap 170 may include a flange 180 (e.g., a flange providing a tool engagement surface) and a shank 182 (e.g., a shank having a substantially circular cross-section in a direction perpendicular to the longitudinal axis X) extending from flange 180 and terminating at reaction surface 178. In the example shown, shank 182 defines external threads 184 configured to threadedly engage internal threads 186 of intermediate sleeve 150.

In some examples, pressure relief valve 104 may include one or more fluid-resistant seals (e.g., one or more fluid-tight seals) between at least some components of pressure relief valve 104 for reducing the likelihood or preventing passage of fluid between the one or more components. For example, example pressure relief valve 104 shown in FIG. 1 includes a seal 188 (e.g., an O-ring seal) received in an annular groove 190 of seat portion 130 to provide a fluid-resistant seal between seat portion 130 and housing 108. Example pressure relief valve 104 shown in FIG. 1 also includes a seal 192 (e.g., an O-ring seal) received in an annular groove 194 of cage 128 to provide a fluid-resistant seal between cage 128 and seat portion 130. Example pressure relief valve 104 shown in FIG. 1 also includes a seal 196 (e.g., an O-ring seal) received in an annular groove 198 of piston portion 144 of keeper 140 to provide a fluid-resistant seal between piston portion 144 and cage 128. Example pressure relief valve 104 shown in FIG. 1 also includes a seal 200 (e.g., an O-ring seal) received in an annular groove 202 in an exterior surface 204 of cage 128 to provide a fluid-resistant seal between exterior surface 204 and cage 128.

In the example shown in FIG. 1, housing 108 includes an outlet end 206 defining a substantially circular cross-section perpendicular to the longitudinal axis Y of outlet passage 112. At a remote end of outlet end 206, example housing 108 defines exterior threads 208 configured to receive complimentary interior threads associated with fluid lines 106 and/or an exhaust line. In some examples, outlet end 206 of outlet passage 112 may be configured to be in flow communication with fluid system 100. Some examples may include a seal ring 210 received in outlet passage 112 and configured to provide a fluid resistant seal (e.g., a fluid-tight seal) between outlet end 206 and a fluid line or component.

FIG. 2 is a schematic side section view of the example pressure relief valve 104 shown in FIG. 1 in an example open state. As shown in FIG. 2, when fluid pressure in inlet passage 110 reaches or exceeds a threshold pressure, relief body 138 is forced against piston portion 144 of keeper 140 with sufficient force to overcome a reactive force provided by waveform spring 166, such that relief body 138 moves away from seat portion 130, thereby providing flow communication via a flow path 212 between inlet passage 110 and outlet passage 112. For example, relief body 138 presses against piston portion 144, which, in turn, presses against waveform spring 166, which presses against reaction surface 178 of end cap 170 until the reactive force provided by waveform spring 166 is exceeded. This, in turn, relieves pressure in fluid system 100 until the pressure falls below a pressure sufficient to allow the reactive force provided by waveform spring 166 to return relief body 138 to seat portion 130, thereby closing pressure relief valve 104 and preventing flow communication between inlet passage 110 and outlet passage 112.

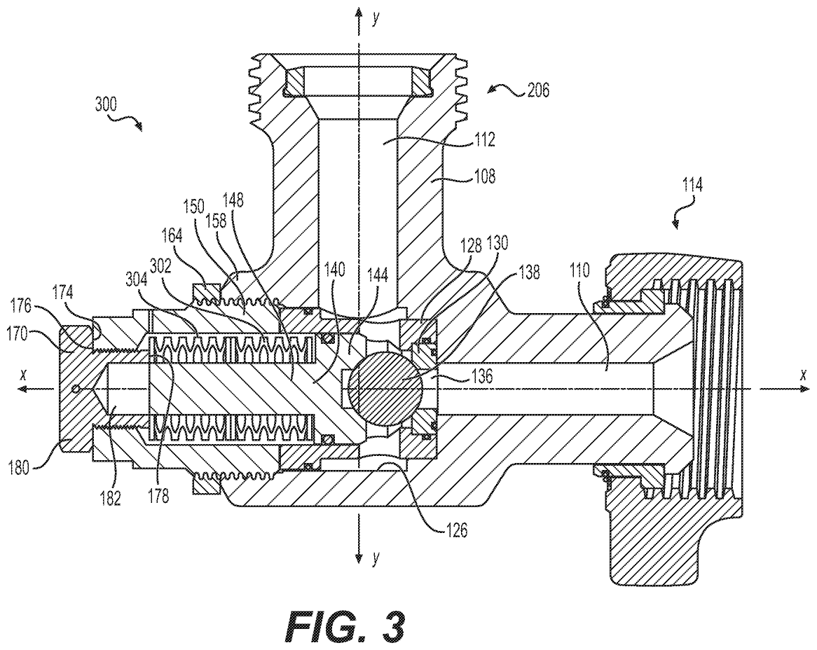

FIG. 3 is a schematic side section view of another example pressure relief valve 300 in an example closed state. Example pressure relief valve 300 shown in FIG. 3 is substantially the same as example pressure relief valve 104 shown in FIGS. 1 and 2, except that example pressure relief valve 300 includes two waveform springs 302 and 304 rather than a single waveform spring, for example, as is present in example pressure relief valve 104 shown in FIG. 1. For example, waveform spring 302 and waveform spring 304 may be arranged in series, such that they are arranged in an end-to-end relationship, for example, as shown in FIG. 3. It is contemplated that pressure relief valve 300 may include more than two waveform springs. Inclusion of multiple waveform springs may be used to tailor the reactive force provided by the waveform springs to correspond to the desired threshold pressure at or above which pressure relief valve 300 will open to relieve pressure in inlet passage 110 and/or fluid system 100 (see FIGS. 1 and 2).

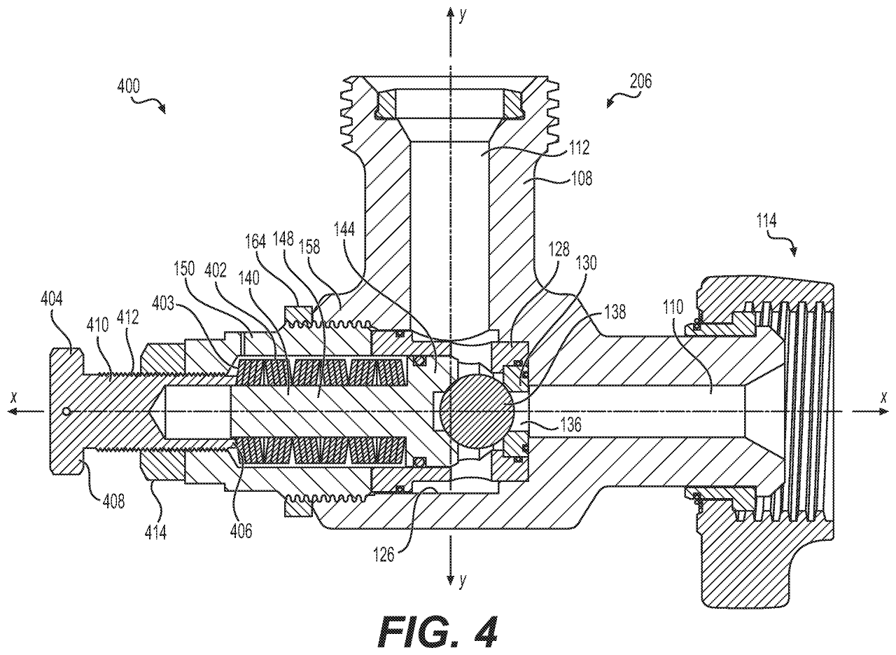

FIG. 4 is a schematic side section view of another example pressure relief valve 400 in an example closed state. Example pressure relief valve 400 shown in FIG. 4 is similar to example pressure relief valve 104 shown in FIGS. 1 and 2 and example pressure relief valve 300 shown in FIG. 3, except that example pressure relief valve 400 includes a plurality of spring relief washers 402 (e.g., Belleville washers) and an adjustment screw 404 for adjusting a threshold pressure at which pressure relief valve 400 opens. For example, spring relief washers 402 may be combined and/or arranged about relief stem 148 and configured to provide a reaction force preventing relief body 138 from moving away from seat portion 130 and opening pressure relief valve 400, unless pressure in inlet passage 110 reaches or exceeds a threshold pressure corresponding to the desired threshold pressure at or above which pressure relief valve 400 will open to relieve pressure in inlet passage 110 and/or fluid system 100.

Example adjustment screw 404 is configured to abut a remote spring relief washer 403 remote from piston portion 144 of keeper 140 to provide a reactive force against the remote spring relief washer 403 to provide a desired resistance to movement of relief body 138 away from seat portion 130. For example, as shown, example adjustment screw 404 may include a reaction surface 406 against which remote spring relief washer 403 abuts. For example, adjustment screw 404 may include a flange 408 (e.g., a flange providing a tool engagement surface) and a shank 410 (e.g., a shank having a substantially circular cross-section in a direction perpendicular to the longitudinal axis X) extending from flange 408 and terminating at reaction surface 178. In the example shown, shank 410 defines external threads 412 configured to threadedly engage internal threads 186 of intermediate sleeve 150.

In the example shown in FIG. 4, spring relief washers 402 and/or adjustment screw 404 may be used to adjust the threshold pressure at or above which pressure relief valve 400 opens to relieve pressure in inlet passage 110 and/or fluid system 100. For example, spring relief washers 402 may be arranged in combinations of orientations in order to change a biasing force and reaction force provided by spring relief washers 402, for example, according to known techniques. In addition, or alternatively, adjustment screw 404 may be rotated relative to intermediate sleeve 150 to cause adjustment screw 404 to move farther into or out of relief cavity 154, thereby changing the amount of pressure against remote spring relief washer 403 provided by reaction surface 178 of adjustment screw 404, which, in turn, adjusts the threshold pressure at or above which pressure relief valve 400 opens to relieve pressure in inlet passage 110 and/or fluid system 100. As shown in FIG. 4, some examples of pressure relief valve 400 may include a fastener 414 (e.g., a nut) for securing adjustment screw 404 in a desired location relative to intermediate sleeve 150, for example, following positioning of adjustment screw 404 to provide pressure relief at or above the desired threshold pressure.

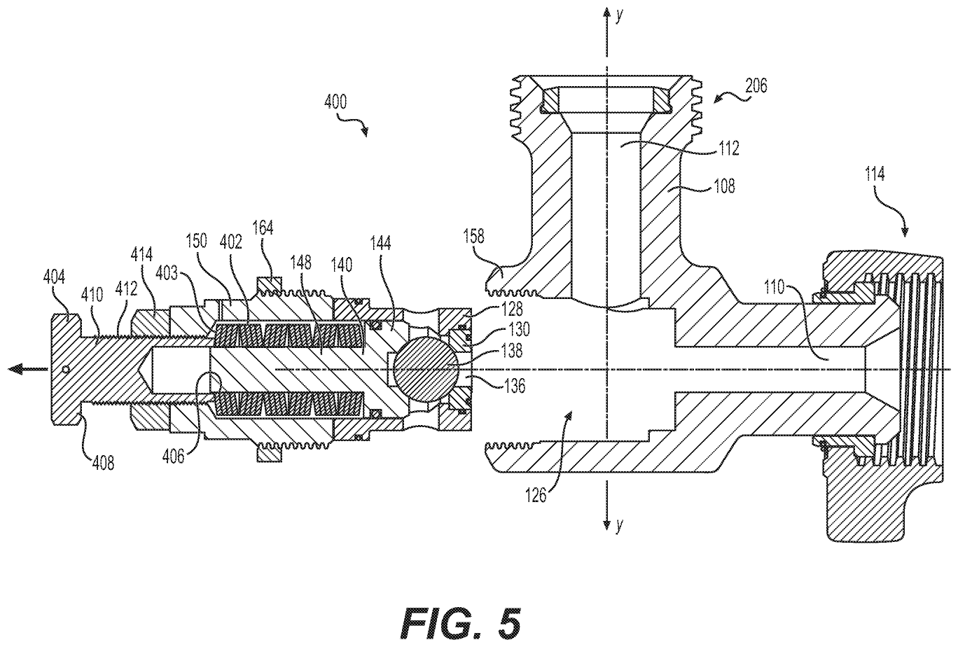

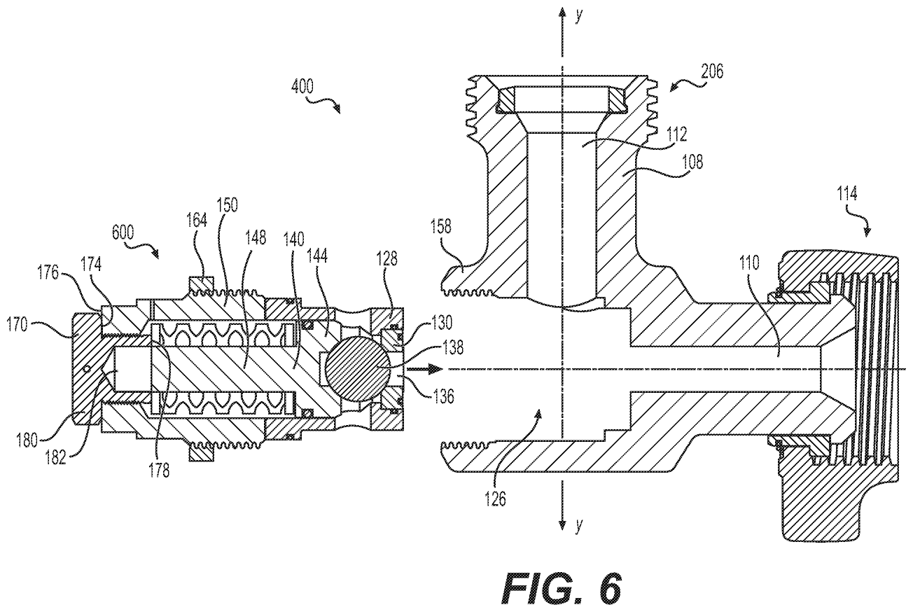

FIG. 5 is a schematic side section view of example pressure relief valve 400 shown in FIG. 4 during an example servicing procedure, and FIG. 6 is a schematic side section view of example pressure relief valve 400 during the example servicing procedure using an example service system 600 including example replacement components being associated with pressure relief valve 400. As shown in FIG. 5, during an example servicing procedure, one or more components of pressure relief valve 400 may be separated from pressure relief valve 400, and one or more of the removed components may be replaced with new, different, and/or reconditioned components, for example, as shown in FIG. 6. For example, following use of pressure relief valve 400, one or more components of pressure relief valve 400 may become worn through normal operation. Rather than replacing the entire pressure relief valve 400, one or more components may be replaced with new, different, and/or reconditioned components, so that pressure relief valve 400 may continue to be used.

For example, adjustment screw 404 and/or at least some of spring relief washers 402 (e.g., all of spring relief washers 402) may be separated from pressure relief valve 400, and in some examples, at least some of spring relief washers 402 may be replaced by one or more waveform springs 166 (see FIGS. 1, 2, 3, and 6), and/or adjustment screw 404 may be replaced by end cap 170. In some examples, for example, as shown FIG. 6, all of spring relief washers 402 may be replaced by a single waveform spring 166 configured to provide a reaction force corresponding to a desired threshold pressure at or above which pressure relief valve 400 will relieve pressure in inlet passage 110 and/or fluid system 100, for example, as described herein. In some examples, for example, as shown FIG. 6, adjustment screw 404 may be replaced by end cap 170, which may be configured such that no adjustment is necessary for setting the reaction force corresponding to the desired threshold pressure at or above which pressure relief valve 400 will relieve pressure, for example, as described herein. For example, unlike adjustment screw 404, which may be used to adjust the reaction force provided by spring relief washers 402 (or waveform spring 166), end cap 170 may be configured such that end cap 170 is threaded into intermediate sleeve 150 and tightened until shoulder 174 abuts against end surface 176 of intermediate sleeve 150 in a secured manner, and such that waveform spring 166 provides a reaction force corresponding to the desired threshold pressure at or above which pressure relief valve 400 relieves pressure in inlet passage 110 and/or fluid system 100. In some examples, once end cap 170 is tightened against intermediate sleeve 150, no further adjustment of pressure relief valve 400 or any of its components is necessary to achieve the reaction force corresponding to the desired threshold pressure, thereby reducing the likelihood or preventing an adjustment of the reaction force in manner that results in the threshold pressure being different than desired through improper adjustment of adjustment screw 404 and/or improper installation of spring relief washers 402, either or both of which may result in pressure relief valve 400 having a threshold pressure different than the desired threshold pressure. Thus, in some examples, pressure relief valve 400 may be retrofitted by replacing one or more spring relief washers 402 with one or more waveform springs 166 and/or replacing adjustment screw 404 with end cap 170.

As shown schematically in FIG. 5, during an example servicing procedure, one or more of the components of pressure relief valve 400 may be separated from pressure relief valve 400. For example, fastener 414 may be loosened, allowing separation of adjustment screw 404 from intermediate sleeve 150. Thereafter, fastener 414 may be loosened and/or separated from external threads 162 of intermediate sleeve 150, allowing separation of intermediate sleeve 150 from fixture portion 158 of housing 108. Separation of intermediate sleeve 150 from housing 108, in some examples, may provide access to spring relief washers 402, keeper 140, cage 128, relief body 138, and/or seat portion 130, one or more of which may be separated from housing 108 via chamber 126. Other orders of separating components of pressure relief valve 400 from housing 108 are contemplated. Although FIG. 5 shows fastener 414, adjustment screw 404, fastener 164, intermediate sleeve 150, spring relief washers 402, keeper 140, cage 128, relief body 138, and seat portion 130 separated from housing 108 as a single unit, this is for the sake of clarity, and it is contemplated that one or more of those components are separated from housing 108 individually and/or as subunits, for example, as described herein.

FIG. 6 is a schematic side section view of example pressure relief valve 400 during the example servicing procedure using an example service system 600, including example replacement components being associated with pressure relief valve 400. For example, following separation of components from pressure relief valve 400, for example, as described with respect to FIG. 5, example service system 600 may include one or more components for replacing one or more components separated from pressure relief valve 400 during a servicing procedure. In some examples, one or more components separated from pressure relief valve 400 may be reused and re-inserted into housing 108 of pressure relief valve 400.

As shown in FIG. 6, seat portion 130 and/or cage 128 may be associated with (e.g., inserted into) chamber 126 of housing 108. In some examples, thereafter, seat portion 130 may be coupled to cage 128 prior to insertion into chamber 126. Relief body 138 may be associated with (e.g., inserted into) chamber 126, for example, such that relief body 138 is positioned abutting seat portion 130. In some examples, thereafter, keeper 140 may be associated with (e.g., inserted into) cage 128, for example, such that piston portion 144 slides into cage 128 with relief stem 148 extending away from relief body 138. In some examples, thereafter, one or more waveform springs 166 may be associated with (e.g., inserted over) relief stem 148, for example, as a replacement for one or more spring relief washers 402 (see FIGS. 4 and 5). In some examples, thereafter (or before association of waveform spring(s) 166 with relief stem 148) intermediate sleeve 150 may be associated with fixture 158 or housing 108, for example, by threading intermediate sleeve 150 into housing 108 and over waveform spring(s) 166, such that end surface 152 (see FIG. 1) abuts against an end of cage 128 remote from seat portion 130. In some examples, thereafter, fastener 164 may be associated with (e.g., threaded onto) intermediate sleeve 150 and tightened against an exterior end of fixture 158, for example, to secure intermediate sleeve 150 in fixture 158 of housing 108. In some examples, thereafter, end cap 170 may be associated with (e.g., threaded into) intermediate sleeve 150, for example, as a replacement for adjustment screw 404, until shoulder 174 tightly abuts against end surface 176 of intermediate sleeve 150, thereby providing reaction surface 178 against which waveform spring(s) 166 abut(s) to provide a reaction force against keeper 140 and relief body 138 to prevent relief body 138 from moving away from seat portion 130, unless pressure in inlet passage 110 and/or fluid system 100 (FIG. 1) reaches or exceeds a desired threshold pressure at or above which pressure relief valve 400 operates to relieve pressure in inlet passage 110 and/or fluid system 100. In some examples, replacement of at least some (e.g., all) of pressure relief washers 402 with one or more waveform springs 166 eliminates the need to properly arrange and/or orient spring relief washers 402 to achieve the desired threshold pressure for pressure relief valve 400.

In some examples, replacement of adjustment screw 404 with end cap 170 eliminates the need to properly adjust and/or position adjustment screw 404 into intermediate sleeve 150 to achieve the desired threshold pressure for pressure relief valve 400. Other components of pressure relief valve 400 may be replaced (or not replaced) during some examples of the servicing procedure. Thus, some examples of service system 600 may include other components, in addition to waveform spring(s) 166 and/or end cap 170, for example, as shown in FIG. 6. Although FIG. 6 shows end cap 170, fastener 164, intermediate sleeve 150, waveform spring 166, keeper 140, cage 128, relief body 138, and seat portion 130 being associated with (e.g., inserted into) housing 108 as a single unit, this is for the sake of clarity, and it is contemplated that one or more of those components are associated with housing 108 individually and/or as subunits.

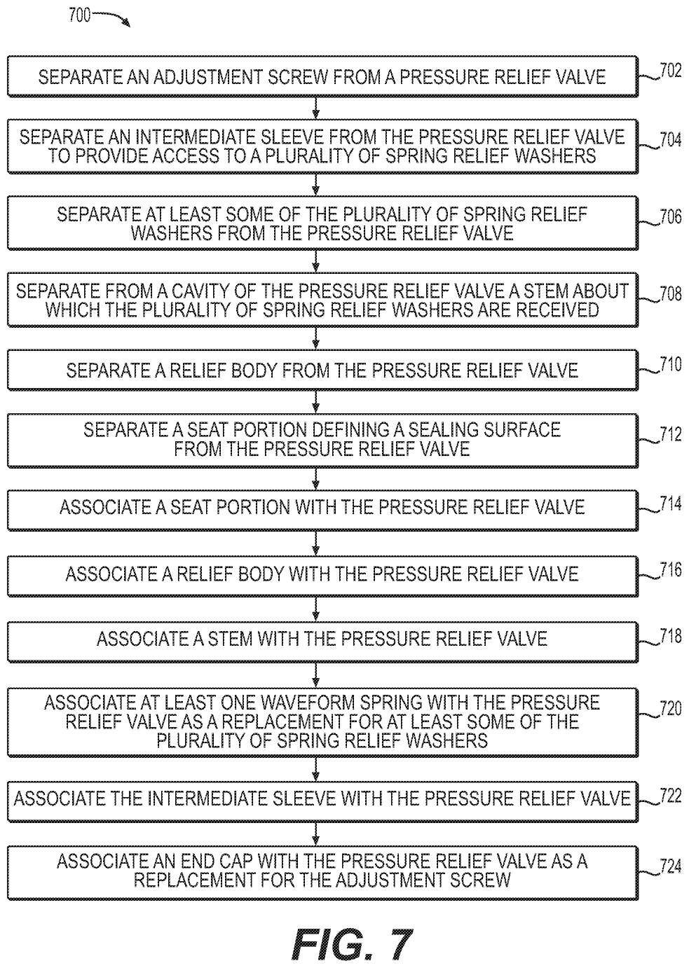

FIG. 7 illustrates an example process 700 for servicing a pressure relief valve including a plurality of spring relief washers and an adjustment screw for adjusting a threshold pressure at which the pressure relief valve opens. The process is illustrated as a logical flow graph. The order in which the operations are described is not intended to be construed as a limitation, and any number of the described operations can be combined in any order and/or in parallel to implement the process. The following actions described with respect to FIG. 7 may be performed, for example, as illustrated with respect to FIGS. 4-6.

The example process 700, at 702, may include separating the adjustment screw from the pressure relief valve (e.g., from a housing of the pressure relief valve). For example, a fastener (e.g., a nut) securing the adjustment screw to an intermediate sleeve may be loosened, and the adjustment screw may be unthreaded from the intermediate sleeve.

At 704, the example process 700 may include separating the intermediate sleeve from the pressure relief valve (e.g., from the housing of the pressure relief valve) to provide access to the plurality of spring relief washers. For example, a fastener (e.g., a nut) securing the intermediate sleeve to the housing of the pressure relief valve may be loosened, and the intermediate sleeve may be unthreaded from the housing.

In some examples, the process 700, at 706, may include separating at least some of the plurality of spring relief washers from the pressure relief valve (e.g., from the housing of the pressure relief valve). In some examples, this may be part of the process at 708.

The example process 700, at 708, may include separating from a cavity of the pressure relief valve a stem about which the plurality of spring relief washers is received. In some examples, the pressure relief washers may be removed with the stem. In some examples, the stem may be part of (or coupled to) a keeper.

At 710, the example process 700 may include separating a relief body from the pressure relief valve (e.g., from the housing of the pressure relief valve). In some examples, this may include separating a cage including (or coupled to) a seat portion from the pressure relief valve.

In some examples, the process 700, at 712, may include separating a seat portion defining a sealing surface from the pressure relief valve (e.g., from the housing of the pressure relief valve). In some examples, this may include separating a cage including (or coupled to) the seat portion from the pressure relief valve.

The example process 700, at 714, may include associating a seat portion with the pressure relief valve (e.g., inserting the seat portion into) the pressure relief valve (e.g., into the housing of the pressure relief valve). In some examples, the seat portion may be the seat portion separated from the pressure relief valve at 712. In some examples, the seat portion may be a replacement for the seat portion separated from the pressure relief valve at 712, and the replacement seat portion may have the same (or a different) configuration relative to the seat portion separated from the pressure relief valve at 712. In some examples, the seat portion may be associated with a cage (e.g., coupled to the cage), and the cage may be associated with (e.g., inserted into) the pressure relief valve.

At 716, the example process 700 may include associating a relief body with the pressure relief valve (e.g., inserting the relief body into the pressure relief valve, for example, into the housing), for example, such that the relief body is received by the seat portion. In some examples, the relief body may be the relief body separated from the pressure relief valve at 710. In some examples, the relief body may be a replacement for the relief body separated from the pressure relief valve at 710, and the replacement relief body may have the same (or a different) configuration relative to the relief body separated from the pressure relief valve at 710.

In some examples, the process 700, at 718, may include associating a stem with the pressure relief valve (e.g., inserting the stem into) the pressure relief valve (e.g., into the housing of the pressure relief valve). In some examples, the stem may be the stem separated from the pressure relief valve at 708. In some examples, the stem may be a replacement for the stem separated from the pressure relief valve at 708, and the replacement stem may have the same (or a different) configuration relative to the stem separated from the pressure relief valve at 708. In some examples, the stem may be associated with a keeper (e.g., coupled to the keeper), and the keeper may be associated with (e.g., inserted into) the pressure relief valve.

The example process 700, at 720, may include associating at least one waveform spring with the pressure relief valve (e.g., the housing) as a replacement for at least some of the plurality of spring relief washers. In some examples, the one or more waveform springs may replace all the spring relief washers. In some examples, the one or more waveform springs may include a single waveform spring or two or more waveform springs.

At 722, the example process 700 may include associating an intermediate sleeve with the pressure relief valve (e.g., inserting the intermediate sleeve into the pressure relief valve, for example, into the housing), for example, such that the intermediate sleeve abuts a portion of the cage. In some examples, the intermediate sleeve may be the intermediate sleeve separated from the pressure relief valve at 704. In some examples, the intermediate sleeve may be a replacement for the intermediate spring separated from the pressure relief valve at 704, and the replacement intermediate sleeve may have the same (or a different) configuration relative to the intermediate sleeve separated from the pressure relief valve at 704.

In some examples, the process 700, at 724, may include associating an end cap with the pressure relief valve (e.g., coupling the end cap to the pressure relief valve, for example, the housing) as a replacement for the adjustment screw, for example, such that a shoulder of the end cap abuts an end surface of the intermediate sleeve and a reaction surface of the end cap abuts against an end of the one or more waveform springs.

The example process 700, in some examples, may omit and/or re-order one or more of 702 through 724.

### INDUSTRIAL APPLICABILITY

Some examples of the pressure relief valve may be configured to be in flow communication with a fluid system and relieve pressure in the fluid system, for example, when the pressure in at least a portion of the fluid system reaches or exceeds a threshold pressure corresponding to a highest desired pressure in the fluid system. For example, the pressure relief valve may be configured to prevent the pressure in the fluid system from exceeding a maximum desired pressure, which may serve to reduce the likelihood or prevent the pressure in the fluid system from damaging components of the fluid system and/or creating an undesirable condition associated with the fluid system. For example, the fluid system may be used to communicate one or more liquids, gases, semi-solids, and/or solids via fluid lines, for example, in flow communication with a fluid source, which may include, for example, one or more reservoirs, pumps, compressors, wells, etc. For example, the fluid system may include one or more fuel systems, lubrication systems, cooling systems, irrigation systems, refrigerant systems, pumping systems, compression systems, well systems, fluid delivery systems, and/or air systems.

In some examples, the pressure relief valve may include one or more waveform springs configured to resist movement of a relief body away from a seat portion, for example, such that the relief body prevents flow communication between an inlet passage and an outlet passage of the pressure relief valve, for example, when pressure in the inlet passage is below a threshold pressure and such that the relief body moves away from the seat portion when the pressure in the inlet passage is at or exceeds the threshold pressure, thereby relieving pressure in the inlet passage and a portion of the fluid system in flow communication with the inlet passage. In some examples, a first end of the one or more waveform springs may provide a biasing force against movement of the relief body away from the seat portion, and in some examples, the waveform spring may be selected to provide a desired biasing force and/or have a length, such that the relief body prevents flow communication between the inlet passage and the outlet passage, for example, when pressure in the inlet passage is below the threshold pressure, and such that the relief body moves away from the seat portion when the pressure in the inlet passage reaches or exceeds the threshold pressure, thereby relieving pressure in the inlet passage and/or the portion of the fluid system in flow communication with the pressure relief valve.

In some examples, because the one or more waveform springs are used to create the biasing force, for example, rather than arrangements and/or combinations of spring relief washers, providing the desired threshold pressure may be relatively less complex. For example, arrangements and/or combinations of spring relief washers may provide many different levels of biasing force, depending on the combinations and/or arrangements (e.g., orientations), and thus, it is possible to unintentionally arrange and/or combine the spring relief washers in a way that results in an intended level of biasing force. In contrast, use of one or more (e.g., a single) waveform spring rather than, for example, spring relief washers, may render it less complex and/or more predictable to provide a desired level of biasing force corresponding to a desired threshold pressure for the pressure relief valve. This may reduce the likelihood of the pressure relief valve having a threshold pressure other than the desired threshold pressure, for example, when manufactured, installed in flow communication with a fluid system, serviced in the field by a technician, and/or reconditioned, for example, as described herein.

In some examples, the pressure relief valve may include an end cap rather than, for example, as adjustment screw configured to facilitate adjustment of the threshold pressure, for example, as described herein. For example, the end cap may be configured to abut a second end of the one or more waveform springs (e.g., an end opposite the end adjacent the relief body) to provide a reactive force against the second end of the one or more waveform springs to provide a desired resistance to movement of the relief body away from the seat portion. In some examples, the end cap may include a shoulder configured to abut an end surface of an intermediate sleeve facing away from the inlet end of the pressure relief valve housing. When coupled to the pressure relief valve, the end cap may be threaded into the intermediate sleeve and tightened, such that the shoulder tightly abuts the end of the intermediate sleeve, thereby not providing adjustment of the threshold pressure via tightening and loosening of the end cap, for example, as compared to an adjustment screw, which may serve to preload the biasing force and increasing the threshold pressure in the pressure relief valve having an adjustment screw. Providing the end cap may reduce the likelihood of the pressure relief valve having a threshold pressure other than the desired threshold pressure, for example, when manufactured, installed in flow communication with a fluid system, serviced in the field by a technician, and/or reconditioned, for example, as described herein.

Some examples of the service system and/or servicing procedure described herein may include one or more components for replacing one or more components separated from a pressure relief valve including a plurality of spring relief washers, for example, during a servicing procedure. In some examples, one or more waveform springs may be associated with the pressure relief valve, for example, as replacement(s) for at least some spring relief washers (e.g., all the spring relief washers). This may result in reducing the likelihood that the serviced pressure relief valve has a threshold pressure different than desired as compared to servicing a pressure relief valve and replacing or re-inserting spring relief washers, the combination and/or arrangement of which may be relatively complex and conducive to errors resulting in a threshold pressure differing from the desired threshold pressure, for example, as explained herein.

Some examples of the service system and/or servicing procedure may include associating an end cap with (e.g., threading the end cap into) an intermediate sleeve, for example, as a replacement for an adjustment screw, until a shoulder of the end cap tightly abuts against an end surface of the intermediate sleeve, thereby providing a reaction surface against which the one or more waveform springs abut to provide a reaction force against the relief body to prevent the relief body from moving away from the seat portion, unless pressure in the inlet passage and/or fluid system reaches or exceeds a desired threshold pressure at or above which the pressure relief valve operates to relieve pressure in the inlet passage and/or the fluid system. In some examples, replacement of the adjustment screw with the end cap may reduce or eliminate the need to properly adjust and/or position the adjustment screw into the intermediate sleeve to achieve the desired threshold pressure for the pressure relief valve, for example, as described herein.

While aspects of the present disclosure have been particularly shown and described with reference to the examples above, it will be understood by those skilled in the art that various additional embodiments may be contemplated by the modification of the disclosed devices, systems, and methods without departing from the spirit and scope of what is disclosed. Such embodiments should be understood to fall within the scope of the present disclosure as determined based upon the claims and any equivalents thereof.

What is claimed is:

1. A pressure relief valve comprising:
a housing defining an inlet passage for providing flow communication with a fluid source and an outlet passage spaced from the inlet passage;
a seat portion in flow communication with the inlet passage, the seat portion defining a sealing surface;
a relief body configured to abut the sealing surface and provide a fluid seal between the inlet passage and the outlet passage;
a keeper comprising an engagement surface abutting the relief body;
a relief stem associated with the keeper and extending away from the relief body;
an intermediate sleeve coupled to the housing, the intermediate sleeve defining an end surface and at least partially defining a relief cavity in which the relief stem is received;
at least one waveform spring received in the relief cavity and comprising a first end configured to abut the keeper and resist movement of the relief body and the keeper away from the seat portion, such that the relief body prevents flow communication between the inlet passage and the outlet passage; and
an end cap comprising:
a shoulder abutting the end surface of the intermediate sleeve; and
a reaction surface against which a second end of the at least one waveform spring abuts.

2. The pressure relief valve of claim 1, further comprising a cage received in the housing and associated with the seat portion.

3. The pressure relief valve of claim 2, wherein the intermediate sleeve abuts the cage and prevents the cage from moving relative to the housing.

4. The pressure relief valve of claim 1, wherein the relief stem is coupled to the keeper and extends longitudinally in the relief cavity.

5. The pressure relief valve of claim 1, wherein the at least one waveform spring extends along and substantially surrounds the relief stem.

6. The pressure relief valve of claim 1, wherein the end cap comprises a flange and a shank extending from the flange and terminating at the reaction surface, and wherein the flange defines the shoulder.

7. The pressure relief valve of claim 1, wherein the at least one spring comprises a single spring.

8. A service system for servicing a pressure relief valve comprising a plurality of spring relief washers and an adjustment screw for adjusting a threshold pressure at which the pressure relief valve opens, the service system comprising:
at least one waveform spring configured to be received in a relief cavity of the pressure relief valve and replace at least some of the plurality of spring relief washers, the at least one waveform spring comprising a first end and being configured to resist movement of a relief body away from a seat portion configured to be in flow communication with an inlet passage of the pressure relief valve, such that the relief body prevents flow communication between the inlet passage and an outlet passage of the pressure relief valve; and
an end cap comprising:
a shoulder configured to abut an end surface of the pressure relief valve; and
a reaction surface configured to abut a second end of the at least one waveform spring.

9. The service system of claim 8, further comprising a keeper comprising an engagement surface configured to abut the relief body.

10. The service system of claim 9, a relief stem associated with the keeper and configured to extend away from the relief body.

11. The service system of claim 8, further comprising a cage associated with the seat portion and configured to be received in the pressure relief valve.

12. The service system of claim 11, wherein the seat portion comprises an annular retaining ring coupled to the cage.

13. The service system of claim 11, wherein the cage defines an exterior surface defining an annular cage groove, and wherein the service system further comprises an annular seal ring configured to engage the annular cage groove.

14. The service system of claim 8, wherein the at least one waveform spring comprises a single waveform spring.

15. A method for servicing a pressure relief valve comprising a plurality of spring relief washers and an adjustment screw for adjusting a threshold pressure at which the pressure relief valve opens, the method comprising:
separating the adjustment screw from the pressure relief valve;
separating an intermediate sleeve from the pressure relief valve to provide access to the plurality of spring relief washers;
separating at least some of the plurality of spring relief washers from the pressure relief valve;
associating at least one waveform spring with the pressure relief valve as a replacement for the at least some of the plurality of spring relief washers;
coupling the intermediate sleeve to the pressure relief valve; and
coupling an end cap to the pressure relief valve as a replacement for the adjustment screw, such that a shoulder of the end cap abuts an end surface of the intermediate sleeve and a reaction surface of the end cap abuts an end of the at least one waveform spring.

16. The method of claim 15, further comprising:
separating from a cavity of the pressure relief valve a stem about which the plurality of spring relief washers is received;
separating a first relief body from the pressure relief valve; and
inserting a second relief body into the pressure relief valve as a replacement first relief body.

17. The method of claim 16, further comprising:
separating a first seat portion defining a sealing surface from the pressure relief valve; and
inserting a second seat portion into the pressure relief valve as a replacement for the first seat portion.

18. The method of claim 17, wherein separating the first seat portion from the pressure relief valve comprises removing a cage associated with the first seat portion from the pressure relief valve.

19. The method of claim 16, wherein:
the plurality of spring relief washers is received on a stem in a relief cavity at least partially defined by the intermediate sleeve;
separating at least some of the plurality of spring relief washers from the pressure relief valve comprises removing the at least some of the plurality of spring relief washers from the stem; and
associating the at least one waveform spring with the pressure relief valve comprises mounting the at least one waveform spring over the stem.

20. The method of claim 16, wherein separating at least some of the plurality of spring relief washers from the pressure relief valve comprises separating the plurality of spring relief washers from the pressure relief valve, and associating the at least one waveform spring with the pressure relief valve as a replacement for the plurality of spring relief washers comprises associating a single waveform spring with the pressure relief valve as a replacement for the plurality of spring relief washers.
